(19) United States
(12) Patent Application Publication
(10) Pub. No.: US 2025/0044210 A1
(43) Pub. Date: Feb. 6, 2025

(54) METHODS FOR OPTIMIZING THE SELECTION OF POINTS TO OBTAIN FORMATION STATIC PRESSURE BASED ON THE RELATION BETWEEN THE PERMEABILITY INDEX AND THE EFFECTIVE POROSITY

(71) Applicant: PETRÓLEO BRASILEIRO S.A. – PETROBRAS, Rio de Janeiro (BR)

(72) Inventors: BRUNO CAVALCANTI DE PAULA, Rio de Janeiro (BR); ARTUR ALEXANDRE MACENA DE OLIVEIRA, Rio de Janeiro (BR); ANTONIO CARLOS DE FREITAS NASCIMENTO, Rio de Janeiro (BR)

(21) Appl. No.: 18/734,313

(22) Filed: Jun. 5, 2024

(30) Foreign Application Priority Data
Jul. 31, 2023 (BR) 1020230153909

(51) Int. Cl. G01N 15/08; G01N 24/08

(52) U.S. Cl. CPC G01N 15/0826; G01N 15/088; G01N 24/081

(57) ABSTRACT

The present disclosure refers to a method for optimizing the selection of points to obtain formation static pressure based on the relation between the permeability index and the effective porosity. In an embodiment of a method is disclosed for marking out which intervals are most suitable for carrying out pressure measurements with wireline testers.

### FIELD OF THE DISCLOSURE

The present disclosure pertains to the technical field of oil and gas; more specifically, it is related to exploration and production in oil fields; and more specifically, to monitoring wireline logging operations or during drilling.

### BACKGROUND OF THE DISCLOSURE

It is currently known that the static pressure records obtained during the petrophysical assessment of a well provide essential information for understanding reservoirs during the exploration and production phase in the oil fields.

The choice of points for recording static pressure is currently made through the selection of the largest porosities obtained in nuclear magnetic resonance loggings, when acquired, and, in the absence of NMR loggings, other loggings such as density and neutrons can provide data of porosity. The choice is made mainly based on the highest porosity values estimated per logging. Between the upper and lower limits of effective porosity, the case of selecting the largest porosities becomes clear.

In the search for a performance with assertiveness and precision in the shortest possible time, the objective was to generate a method to mark out which intervals are most suitable for carrying out pressure measurements with testers, thus reducing operating time on the drilling rig and seeking better quality of the obtained data. The upper porosity limit is trivially found. However, what is the porosity cutoff value to mark out the choices of points to be sampled?

In the aforementioned context, the present disclosure refers to embodiments of a method that aims at establishing the lower limit for the interval of effective porosity used to carry out pressure measurements, which is based on the estimate of the first inflection point of the first derivative of the sigmoidal function fitted to the effective porosity distribution and sum of the normalized permeability index.

Among the advantages presented by the present disclosure, there is a reduction in operating time (cutting rig costs) for the pressure measurement operation on a drilling rig, since it marks out/directs the operation to the intervals of better quality and greater probability of obtaining ideal static pressures, in addition to making it possible to exclude points that would be tested, which are less likely to obtain ideal static pressure data. Furthermore, a reduction in payment for poor quality pressure measurement points is also observed.

### STATE OF THE ART

In the state of the art, there are methods to assess a reservoir; however, the methods of the state of the art present deficiencies when compared to the method of the present disclosure, as generally speaking no method of the state of the art allows obtaining recording data of formation static pressure that is of quality and in the shortest possible time.

Patent document U.S. Pat. No. 6,691,037B1, for example, refers to the field of well logging. More specifically, it refers to methods for estimating formation permeability, describing methods for calibrating a formation permeability model against data obtained from fluid flow measurements. That is, document U.S. Pat. No. 6,691,037B1 discloses methods for calibrating a formation permeability model against data obtained from fluid flow measurements, which includes determining a correlation coefficient for an irreducible porosity-water saturation relation; determining a principal coefficient for a formation permeability model; and determining at least one exponent parameter for the formation permeability model by minimizing a basis function that represents a difference between a formation permeability estimate derived from the formation permeability model and a formation permeability estimate derived from fluid flow measurements.

However, the present disclosure differs from document U.S. Pat. No. 6,691,037B1, mainly because it aims at obtaining the effective porosity to the estimate from the technique of flow capacity regimes, focusing on assertiveness and precision in the shortest possible time, despite U.S. Pat. No. 6,691,037B1 considering parameters also used in the calculations of analyses carried out by the method of the present disclosure, such as permeability.

In turn, document U.S. Pat. No. 6,032,101A addresses to processes for assessing the subterranean formation. Specifically, process for the determination of parameters that characterize the formation using recorded NMR (nuclear magnetic resonance) data, especially in conjunction with other types of recorded data. Some objects of the Disclosure are to provide processes that accurately determine parameters using virtually any conventional NMR tool, to provide processes to determine total gas-corrected porosity and gas saturation of the drained zone by combining NMR recording and density measurements, the combination of NMR measurements with other open-hole recordings to determine fundamental petrophysical parameters such as permeability and hydrocarbon saturation and producibility, in addition to estimating the uncertainty of the magnitudes of petrophysical parameters determined in accordance with the Disclosure.

However, the present disclosure differs from document U.S. Pat. No. 6,032,101A, because, although this document considers parameters used in the methodology of the present disclosure, such as permeability and porosity through data recorded in a nuclear magnetic resonance tool, document U.S. Pat. No. 6,032,101A does not defines a lower limit of porosity for carrying out pressure measurements.

Document CN112392477A in turn protects a method for rapid prediction of single well potential, which comprises the following steps: obtaining a permeability constant, a saturation constant, a formation static pressure constant and a sandstone thickness constant according to permeability, natural gas saturation, formation static pressure, sandstone thickness and exploration porosity in the target area; establishing a gas production equation combining the permeability constant, the saturation constant, the formation static pressure constant, and the sandstone thickness constant to obtain a gas production constant; the method comprises the steps of obtaining measured values of porosity, natural gas saturation, formation static pressure and sandstone thickness of each interval of a well predicted from a volume of logging data, substituting the measured values in an equation of gas production to obtain a gas production value, obtaining a predicted well gas production condition through the gas production value and completing the prediction.

The present disclosure differs from document CN112392477A, as instead of establishing a formation static pressure equation according to the formation static pressure, the present disclosure marks out the choices of points for recording static pressure from the porosity cutoff value.

### BRIEF DESCRIPTION OF THE DISCLOSURE

The present disclosure refers to embodiments of a method for optimizing the selection of points to obtain formation static pressure, comprising being based on the relation between the permeability index and effective porosity, which comprises the steps of: (a) selecting an effective porosity interval for the first campaign or a work plan of static pressure records; (b) using argilosity porosity, irreducible fluid and free fluid readings obtained from the nuclear magnetic resonance (NMR) logging; (c) calculating a permeability index per depth sample; (d) adding and normalizing the permeability index; (c) calculating the effective porosity; (f) plotting a graph of the normalized sum of the permeability index versus the effective porosity, in increasing order of value; (g) analyzing a flow capacity regime chart corresponding to the normalization graph of the sum of the permeability index by effective porosity; (h) obtaining a first derivative of the sigmoidal function, thereby to determine the first inflection point of the curve, through a sigmoidal function fitted to the distribution of step (g); (i) after obtaining an effective porosity value corresponding to the first inflection of the first derivative of the sigmoidal function, applying the same as a minimum cutoff; and (j) carrying the out pressure measurements above the value obtained in step (i). From the increment in effective porosity, the accumulation of permeability begins. The NMR logging does not provide direct permeability; however, a permeability index is calculated through the relation between the porosities obtained by the tool. The method involves calculating the accumulated sum of the permeability index by depth and then normalizing the values of this sum. At each depth of research, the previous accumulated permeability index value will be added, reaching the value of the total sum of the permeability index at the last measured depth of the well, wherein there is an NMR logging. After adding the permeability index data, a ratio of each accumulated permeability index sum value is calculated by the total of the accumulated permeability index sum. The normalization distribution of the permeability index sum (n-Ksom) will have an interval [0,1], wherein the first value in the series will be zero or close to zero, whereas the last value will be one.

### BRIEF DESCRIPTION OF THE DRAWINGS

In order to complement the present description and obtain a better understanding of the features of the present disclosure, and in accordance with a preferred embodiment thereof, in annex, a set of figures is presented, where in an exemplified, although not limiting, manner, its preferred embodiment is represented.

FIG. 1 shows a graph that demonstrates the difficulty of interpreting the Phie graph (effective porosity) versus K (permeability), according to a preferred embodiment of the present disclosure.

FIG. 2 shows a flow capacity graph (FCR), having four intervals, wherein the first interval represents the very low or zero flow capacity, the second interval represents the moderate flow capacity, the third interval represents a good to optimal flow capacity and the fourth interval represents an optimal flow capacity, but without an increase in flow capacity in relation to the previous interval, according to a preferred embodiment of the present disclosure.

FIG. 3 is a graph that represents an example of an NMR logging, wherein the NMR data are the inputs for calculating the permeability index and effective porosity, being: Argilosity Por.=BC, Irreducible fluid Por.=BF and Free fluid Por.=FF, according to a preferred embodiment of the present disclosure.

FIG. 4 represents a graph plotting the distribution of the Phie ratio (effective porosity) and NsumK (normalized sum of the permeability index), according to a preferred embodiment of the present disclosure.

FIG. 5 represents a graph of fitting the sigmoidal function to the distribution of phie e Nsumk, according to a preferred embodiment of the present disclosure.

FIG. 6 represents a graph of the first derivative of the fitted sigmoidal function and point of the first inflection of the curve, according to a preferred embodiment of the present disclosure.

### DETAILED DESCRIPTION OF THE DISCLOSURE

The static pressure records obtained during the petrophysical assessment of a well provide essential information for understanding reservoirs during the exploration and production phase in the oil fields. In the search for a performance with assertiveness and precision in the shortest possible time, the objective was to generate a method to mark out which intervals are most suitable for carrying out pressure measurements with testers.

Normally, the pressure recording points are obtained after acquiring the Nuclear Magnetic Resonance logging. The readings from this logging provide data and interpretations of rock matrix-independent porosity, pore size distribution, irreducible water saturation, identification of fluids, oil viscosity estimation, and permeability index. Among these data, in order to elaborate the method, there are used porosity loggings: argilosity, irreducible fluid and free fluid. The choice of the points for recording static pressure is made by selecting the largest free fluid porosities. However, there is difficulty in choosing the porosity cutoff value to mark out the choices of points to be sampled.

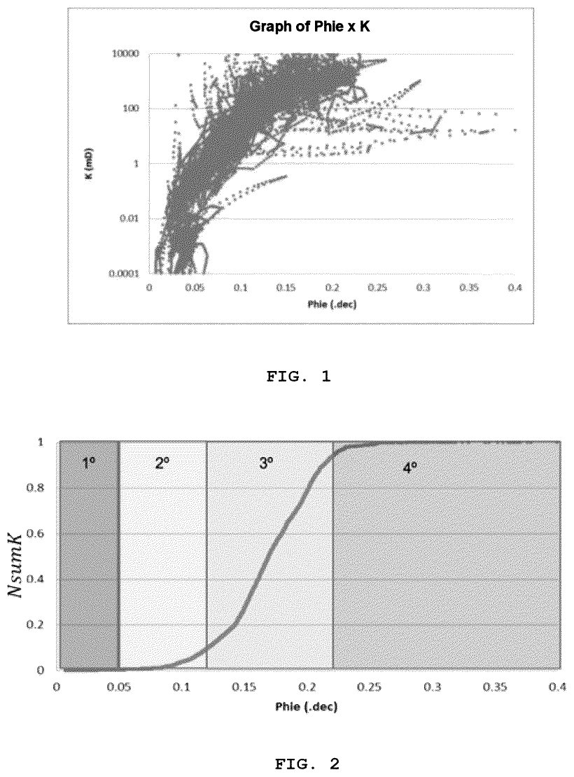

Accordingly, based on the Flow Capacity Regime charts (Nascimento, 2014) for pre-salt carbonate reservoirs where an effective porosity distribution is constructed (sum of the free fluid and irreducible fluid porosities) versus the normalized permeability index sum. The relation between effective porosity (phie) and the permeability index is basically non-linear (FIG. 1) and, to harmonize the scales when correlating the two variables, it is necessary to normalize the accumulated sum of permeability index values (FIG. 2). First, an accumulated sum is calculated, that is, at each depth of research, the sum of the accumulated permeability index value of the previous depth is made. The final value corresponds to the total sum of the permeability indexes.

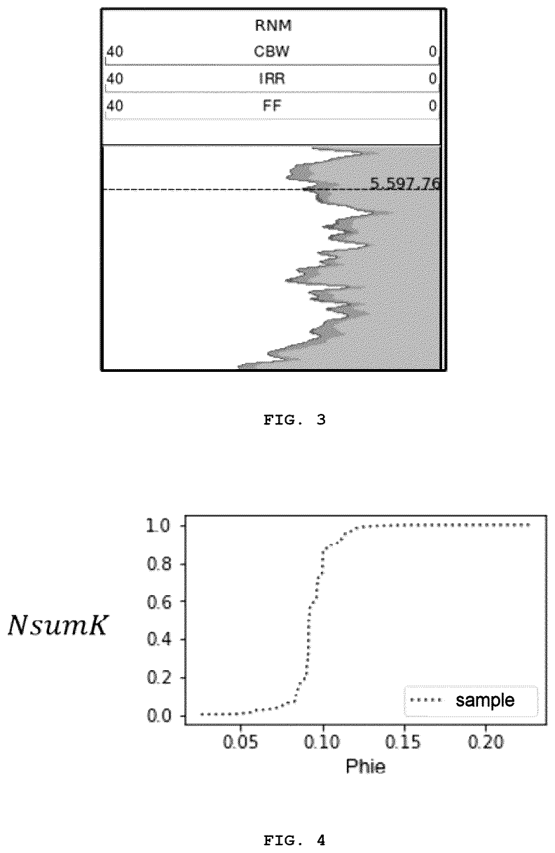

Normalization consists of calculating a ratio of each value of research of the accumulated sum of the permeability index to the sum of the total permeability index. This way, the first value in the series will be zero or close to zero, whereas the last value will be one. In other words, the normalization distribution of the permeability index sum (n-Ksom) will have an interval [0,1], as seen in the graph in FIG. 3.

The Nuclear Magnetic Resonance logging does not provide a direct permeability; however, a permeability index (K) can be calculated through the relation between the porosities obtained by the tool. This artifice is used to classify the porous medium of rock in a field environment. The permeability obtained by inverting rock data is the result of laboratory data, which does not apply to field conditions. In this work, the Timur and Coates equation (0.1) available in the Interactive Petrophysics software (Senergy software version 4.2) was used:

$$k = a \cdot {( \frac{FF}{BF} )}^{b} \cdot {Phit}^{c} \qquad ( 1 )$$

k=permeability index
FF=free fluid
BF=irreducible fluid
Phit=total porosity
a=10000
b=2
c=4

Where “a”, “b” and “c” are constants.

The charts are divided into four intervals of flow capacity regimes.

The first interval is characterized by a very low or zero flow capacity, with the upper limit being indicated by the minute increment in permeability. The second interval has a moderate flow capacity. It is limited to the starting point of the area of greatest accumulation of permeability due to the increment in the effective porosity of the chart. The third interval, characterized as good to optimal flow capacity, houses the first inflection point of the sigmoidal function, that is, it corresponds to the highest rate of permeability variation as a function of porosity. From this point onwards, a slowdown in the accumulation of permeability begins to occur due to the increase in effective porosity. The fourth interval indicates full flow capacity. From this interval onwards, the increase in porosity does not significantly influence the accumulation of permeability, as can be seen in FIG. 1, which represents flow capacity regimes.

The point of interest for cutting, cutoff, of effective porosity, to mark out the pressure measurement operations, corresponds to the lower limit of the third interval. In order to obtain this point, it is necessary to find the first derivative of the sigmoidal function fitted to the effective porosity distribution versus the normalized sum of the permeability index. The first inflection point of the first derivative of the sigmoidal function corresponds to the lower limit of the third interval of Flow Capacity Regime, as shown in FIG. 2. This effective porosity value is the minimum cutoff for pressure measurement operations, according to the following formulas of the sigmoidal function and first derivative of the sigmoidal function, respectively, where e=Euler number and c=constant:

$${Nsumk}_{( phie )} = \frac{1}{1 + {e}^{- c ( phie - {phie}_{0} )}}$$

$${NsumK}_{( phie )}^{′} = \frac{{ce}^{c ( phie - {phie}_{0} )}}{{( {e}^{c ( phie - {phie}_{0} )} - 1 )}^{2}}$$

In other words, the present disclosure is based on the above-mentioned Flow Capacity Regime charts for pre-salt carbonate reservoirs, where an effective porosity distribution is constructed (sum of the free fluid and irreducible fluid porosities) versus the normalized sum of the permeability index. As mentioned previously, the charts are divided into four intervals of flow capacity regimes. From the third interval onwards, there is the point of interest for effective porosity cutoff, to mark out pressure measurement operations, which corresponds to the lower limit of the third interval. The point of interest for effective porosity cutoff, to mark out pressure measurement operations, corresponds to the lower limit of the third interval. To obtain this point it is necessary to find the first derivative of the sigmoidal function fitted to the effective porosity distribution versus the normalized sum of the permeability index. The first inflection point of the first derivative of the sigmoidal function corresponds to the lower limit of the third interval. This effective porosity value is the minimum cutoff for pressure measurement operations of the present disclosure.

Specifically, the methodology of the present disclosure estimates the Phie cutoff (NMR), based on the flow capacity regime, to mark out the pressure measurement operation.

In an embodiment of the disclosure, the choice of formation static pressure recording points is optimized by using the permeability index and the effective porosity, both generated from the nuclear magnetic resonance logging data. Through a normalization graph of the sum of the permeability index by effective porosity, data can be obtained on the types of flow regimes in a well. As effective porosity increases, the rock tends to accumulate permeability.

In another embodiment of the disclosure, the use of the nuclear magnetic resonance (NMR) tool is fundamental in the assessment of formations for carbonate reservoirs; due to the great heterogeneity of these rocks, the basic loggings (gamma rays, resistivity, density, neutrons and sonic) need to be complemented with NMR logging data. The NMR loggings provide data for reservoir assessment, such as porosity independent of rock mineralogy, pore size distribution, irreducible water saturation, fluid identification, oil viscosity estimation and permeability index. The data from the NMR logging used to elaborate this work were porosity data: argilosity, irreducible fluid and free fluid. The vertical resolution of the tool can reach up to 70 cm depending on the company that acquires the data and the resolution one wants to obtain.

In an embodiment of the additional disclosure, the parameters of effective porosity, permeability index and irreducible water saturation are used.

Furthermore, in an embodiment of the method of the present disclosure, as represented in the graph in FIG. 3, in step (a) to define the effective porosity interval for the first static pressure recording campaign, in order to calculate the effective porosity and the permeability index by depth the following equations should be applied:

Total porosity:

$$Phit = BC + BF + FF$$

Effective porosity:

$$Phie = BF + FF$$

Permeability index:

$$K = a . {( \frac{FF}{BF} )}^{b} . {Phit}^{C} \{ \begin{matrix}a = 10. \\ b = 2 \\ c = 4\end{matrix}$$

In step (b), in order to calculate the accumulated sum of the permeability index, the following equation is used:

$${sumK}_{n} = {\sum }_{i = 1}^{n} {k}_{i}$$

In step (c), in order to normalize the accumulated sum of permeability index, there is:

$${NsumK}_{i} = \frac{( {sumK}_{i} - {sumK}_{min} )}{( {sumk}_{max} - {sumk}_{min} )}$$

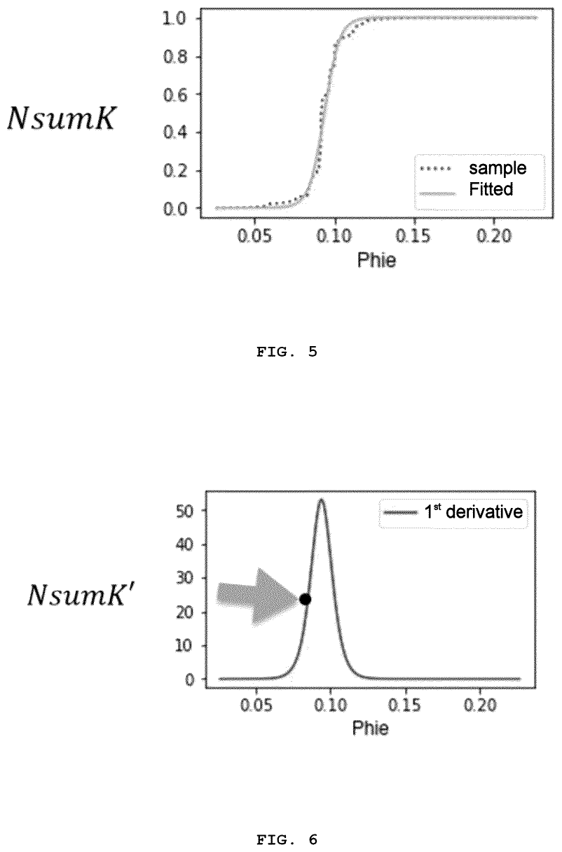

In step (e), as seen in FIGS. 4 and 5, there is carried out a fitting of the sigmoidal function for the distribution of phie e Nsumk, where e=Euler number, c=constant:

$${Nsumk}_{( phie )} = \frac{1}{1 + {e}^{- c ( phie - {phie}_{0} )}}$$

In step (f), as represented in FIG. 6, the first derivative of the sigmoidal function and the meeting of the first inflection of the curve, where e=Euler number, c=constant:

$${NsumK}_{( phie )}^{′} = \frac{{ce}^{c ( phie - {phie}_{0} )}}{{( {e}^{c ( phie - {phie}_{0} )} - 1 )}^{2}}$$

1. A method for optimizing the selection of points to obtain formation static pressure, the method comprising:
(a) selecting an effective porosity interval for the first campaign, or a work plan of static pressure record;
(b) using argilosity porosity, irreducible fluid, and free fluid readings obtained from a nuclear magnetic resonance (NMR) logging;
(c) calculating a permeability index per depth sample;
(d) adding and normalizing a permeability index;
(e) calculating effective porosity;
(f) plotting a graph of a normalized sum of the permeability index versus the effective porosity, in increasing order of value;
(g) analyzing a flow capacity regime chart corresponding to the normalization graph of the sum of the permeability index by effective porosity;
(h) obtaining a first derivative of the sigmoidal function, thereby to determine a first inflection point of the curve, through a sigmoidal function fitted to a distribution of step (g);
(i) after obtaining an effective porosity value corresponding to the first inflection of the first derivative of the sigmoidal function, applying the same as a minimum cutoff; and
(j) carrying the out pressure measurements above the value obtained in step (i).

2. The method according to claim 1, wherein from the increment in effective porosity, the accumulation of permeability begins.

3. The method according to claim 1, wherein the NMR logging does not provide direct permeability, but a permeability index is calculated through the relation between the porosities obtained by the NMR.

4. The method according to claim 1, further comprising calculating the accumulated sum of the permeability index by depth and then normalizing the values of this sum.

5. The method according to claim 4, wherein at each depth, the previous accumulated permeability index value is added, thereby to reach the value of the total sum of the permeability index at the last measured depth of the well, wherein there is an NMR logging.

6. The method according to claim 5, further comprising after adding the permeability index data, a ratio is calculated of each accumulated permeability index sum value by the total of the accumulated permeability index sum.

7. The method according to claim 6, wherein the normalization distribution of the permeability index sum (n-Ksom) has an interval [0,1], wherein the first value of the series is zero or close to zero, and wherein the last value is one.
